(19) United States
(12) Patent Application Publication
(10) Pub. No.: US 2009/0075580 A1
(43) Pub. Date: Mar. 19, 2009

(54) Non-return valve for a ventilation device and such a ventilation device

(75) Inventors: Frank Mootz, Heltersberg (DE); Hubert Loewe, Weselberg (DE); Juergen Hofmann, Eisenberg (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive Electronics & Components

(21) Appl. No.: 12/229,974

(22) Filed: Aug. 28, 2008

(30) Foreign Application Priority Data
Sep. 18, 2007 (DE) 20 2007 013 042.2

(51) Int. Cl. B60H 1/24; F24F 13/08

(52) U.S. Cl. 454/162; 454/359

(57) ABSTRACT

A non-return valve for a ventilation device (10) has ribs (20) which serve to reinforce the non-return valve (16), and a wall thickness (S), the wall thickness (S) of the non-return valve (16) does not vary in the region of the ribs (20).

### TECHNICAL FIELD

The invention relates to a non-return valve for a ventilation device and such a ventilation device.

### BACKGROUND OF THE INVENTION

A ventilation device makes it possible to remove the air which is supplied to the vehicle interior via a ventilation system. The ventilation device has a frame which holds at least one non-return valve. When no air is flowing out of the vehicle interior, the non-return valve lies against the frame, so that moisture, exhaust gas or dirt are prevented from penetrating into the vehicle interior. It is known to produce such ventilation devices from two components, with the frame consisting of a harder material component, whereas the non-return valve is formed from a softer material component. If a higher pressure prevails in the vehicle interior than in the environment of the vehicle, the non-return valve moves into a position in which the air can flow out from the vehicle interior. From a particular quantity of air which flows out of the vehicle interior, the non-return valve begins to flutter, i.e. the non-return valve is caused to vibrate due to the flow of air. The non-return valve which is caused to vibrate rattles, which is a disturbance.

The object of the invention consists in providing a non-return valve and a ventilation device having such a non-return valve, which is able to be produced with little expenditure and is distinguished by good functionality (no rattling).

### BRIEF SUMMARY OF THE INVENTION

This is achieved in a non-return valve for a ventilation device having ribs which serve to reinforce the non-return valve, and a wall thickness, the wall thickness of the non-return valve does not vary in the region of the ribs. The invention is based on the fundamental idea of reinforcing the non-return valve so that it is prevented from fluttering. The non-return valve is reinforced by the ribs. Even in the case of a large amount of air flowing out, i.e. a great force which is acting on the non-return valve, the non-return valve does not flutter because the non-return valve is stiffened by the ribs. The ribs are not elements placed on the non-return valve. Rather, the wall thickness of the non-return valve is constant in the region of the ribs, and the “ribs” are formed by changing the profile of the non-return valve.

The ribs are preferably provided in the longitudinal direction of the non-return valve. The ribs reinforce the non-return valve in the longitudinal direction and prevent the non-return valve from fluttering.

The ribs could just as well be arranged perpendicularly to the longitudinal direction or at any desired angle to the longitudinal direction.

The ribs are preferably parallel to each other, for which reason they reinforce the non-return valve in one direction.

According to one embodiment, the ribs are undulatory when viewed in cross-section. A wave profile is therefore formed which distinguishes itself by its stability.

According to a further embodiment, the ribs are trapezoidal when viewed in cross-section, for which reason a trapezoidal profile is formed.

According to a further embodiment, the ribs are rectangular when viewed in cross-section.

The ribs can also have a sawtooth configuration when viewed in cross-section, for which reason a sawtooth profile is formed.

The non-return valve can be injection-molded, stamped or punched. The non-return valve is made of a plastic of any kind or of rubber of any kind.

The invention further relates to a ventilation device, particularly for venting a vehicle interior, having a non-return valve of the above-mentioned type. Reference is to be made to the above explanations with regard to the advantages.

A frame is preferably provided, on which the non-return valve is mounted. The non-return valve is therefore a separate part which is produced separately from the frame and is subsequently mounted thereon. The non-return valve can be clipped on the frame, for example.

Alternatively, a frame is provided, and the non-return valve is part of the frame. The non-return valve is, for example, injection-molded on the frame. The ventilation device is therefore integral, whereby an assembly of several individual parts is dispensed with. The ventilation device is therefore cost-effective.

### BRIEF DESCRIPTION OF THE DRAWINGS

FIG. 1 shows a sectional view of a ventilation device according to the invention, with a non-return valve according to the invention,

FIGS. 2a to 2f show perspective views of the non-return valve of FIG. 1, in which the non-return valve is respectively constructed as a separate component and is provided with ribs, with FIGS. 2a to 2f showing different variants of the non-return valve,

FIGS. 3a to 3g cross-sections of non-return valves, FIGS. 3a to 3f showing the variants of the non-return valve shown in FIGS. 2a to 2f and FIG. 3g showing a further variant of the non-return valve, and

FIGS. 4a to 4g show perspective views of the non-return valve of FIG. 1, in which the non-return valve is respectively formed integrally with a frame, and FIGS. 4a to 4g show different variants of the non-return valve

### BRIEF DESCRIPTION OF THE PREFERRED EMBODIMENTS

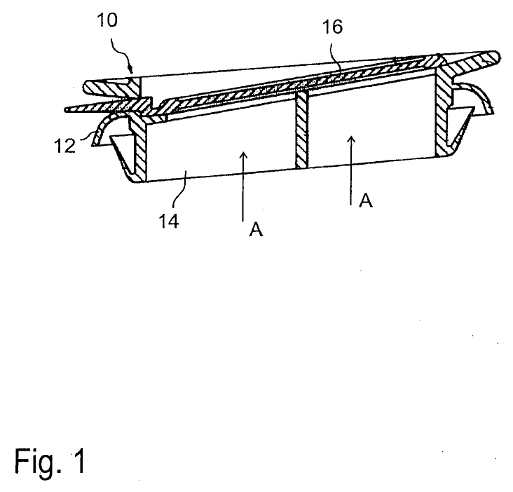

In FIG. 1 a ventilation device 10 is shown, which can be inserted into an opening (not shown) in a support part of a vehicle and which has a frame 12. The frame 12 has at least one outflow opening 14 which can be closed or opened by a respective non-return valve 16. In FIG. 1, the non-return valve 16 is shown in its closed position. The non-return valve 16 is made of a material which allows the non-return valve 16 to be opened by the air flow A from a particular pressure up which prevails in the vehicle interior. The non-return valve 16 can be formed from a soft plastic material and can be produced by injection-molding, stamping, punching or deforming.

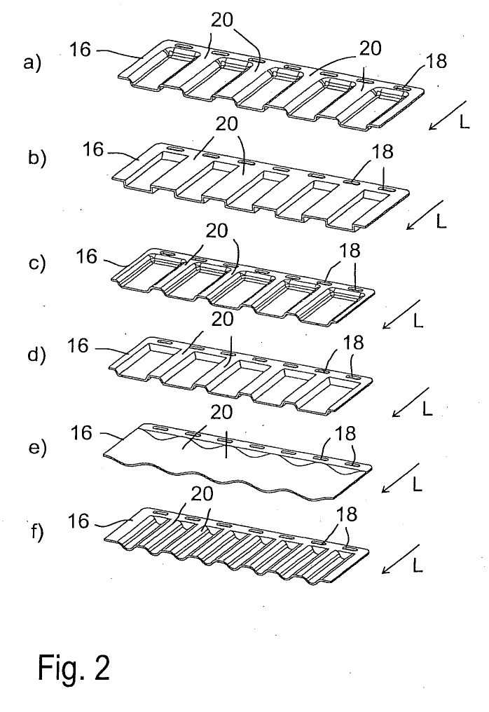

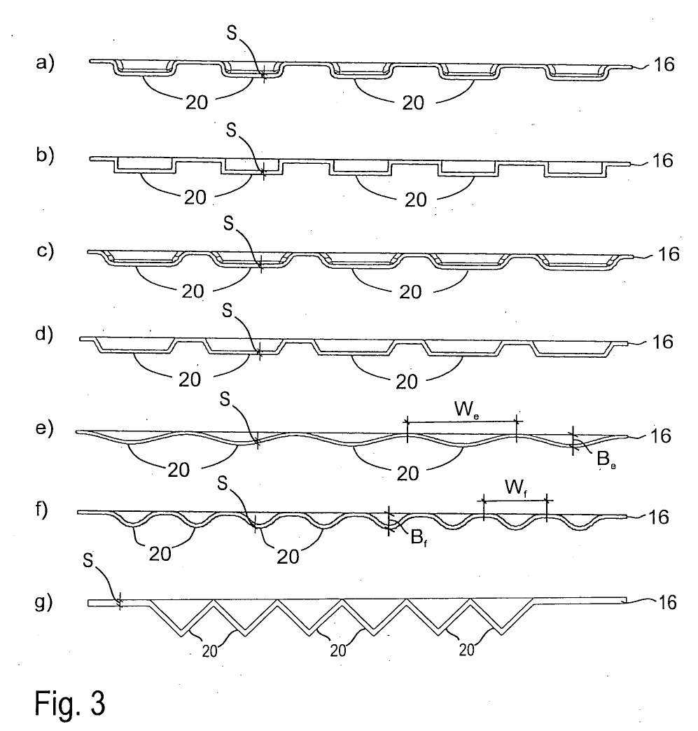

In FIGS. 2 and 3, the non-return valve 16 is shown in different variants. The non-return valve 16 is respectively a separate component and can be mounted on the frame 12. For example, the non-return valve 16 can be clipped on the frame 12. In FIGS. 2a to 2f, several recesses 18 are respectively shown which serve to provide a connection with the frame 12. The frame 12 would have to comprise corresponding projections (not shown) which can reach through the recesses 18 of the non-return valve 16 and can thus establish a connection therewith. Seven recesses 18 are shown respectively, which are arranged on a straight line, with the straight line being perpendicular to the longitudinal direction L of the respective non-return valve 16.

Each non-return valve 16 has respectively several ribs 20 arranged parallel to each other and running in the longitudinal direction L of the non-return valve 16, which ribs 20 reinforce the non-return valve 16 and prevent the non-return valve 16 from fluttering in the case of an escaping air flow A. The ribs 20 are not placed on the non-return valve 16 but formed by a modification of the profile of the non-return valve. That means that the wall thickness of the non-return valve 16 does not vary in the region of the ribs 20. The wall thickness is denoted by S and shown in FIGS. 3a to 3g. The ribs 20 can have different configurations which will be described in detail below.

In FIGS. 2a and 2b, the ribs 20 are configured so as to be substantially rectangular when viewed in cross-section, each rib in FIG. 2a being rounded (see also FIGS. 3a, 3b). The transition of the depressions between the ribs 20 to the region in which the recesses 18 are provided is also rounded in FIG. 2a.

The ribs 20 shown in FIGS. 2c and 2d are trapezoidal when viewed in cross-section and thus configured as trapezoidal profile, with the ribs 20 shown in FIG. 2c being rounded, in contrast to the ribs shown in FIG. 2d (see also FIGS. 3c, 3d). The transition of the depressions between the ribs 20 to the region in which the recesses 18 are provided is also rounded in FIG. 2c.

The ribs 20 shown in FIGS. 2e and 2f are undulatory when viewed in cross-section and thus configured as wave profile, the amplitudes B_{f} of the ribs 20 shown in FIG. 3f being negligibly greater than the amplitudes Bₑ of the ribs 20 shown in FIG. 3e (see also FIGS. 3e, 3f). The undulation length We of the ribs 20 which are shown in FIG. 2e and are undulatory when viewed in cross-section, is several times greater than the undulation length W_{f} of the ribs 20 which are shown in FIG. 2f and are undulatory when viewed in cross-section.

FIG. 3g shows the ribs 20 having a sawtooth configuration when viewed in cross-section.

Although the ribs 20 are arranged in the longitudinal direction L in all the figures, it would be possible to arrange them transversely or obliquely to the longitudinal direction L.

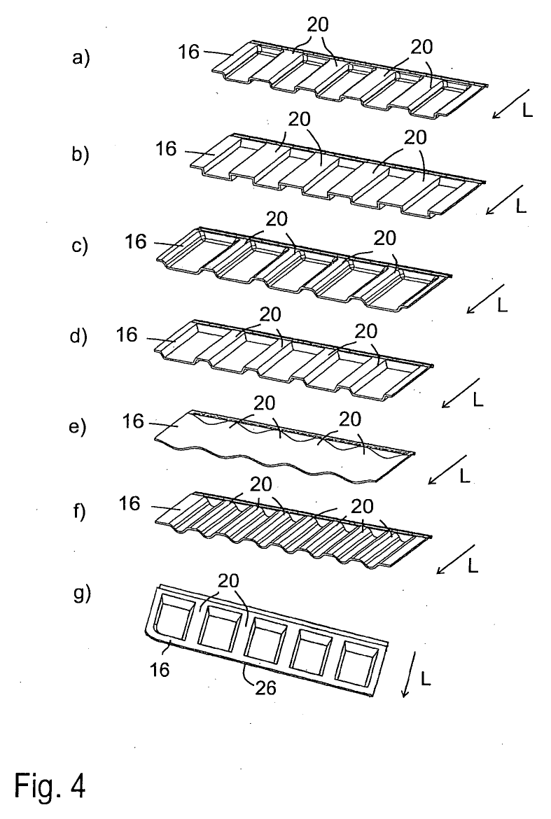

The non-return valves 16 shown in FIGS. 4a to 4f differ from the non-return valves 16 shown in FIGS. 2a to 2f only in that the non-return valves 16 of FIGS. 4a to 4f are formed integrally with the frame 12. In particular, the non-return valves 16 and the frame 12 are formed in a two-component injection-molding process, in which the respective non-return valve 16 is injection-molded onto the frame 12.

The shape of the ribs 20 of FIGS. 4a to 4f, which serve to reinforce the non-return valve 16, corresponds to the shape of the ribs 20 of FIGS. 2a to 2f, by which reference is made thereto.

In FIG. 4g a further variant of a non-return valve 16 with ribs 20 is shown. This differs from those already described in that the ribs 20, when viewed in the longitudinal direction L, terminate at a distance from an edge 26. The ribs 20 of the non-return valves 16 which have already been described extend, on the other hand, up to the edge 26 seen in the longitudinal direction L.

All the embodiments have in common the fact that the non-return valve 16 is configured as a separate component which is mounted on the frame 12. The ribs 20, which are shown in various embodiments, respectively reinforce the non-return valve 16 and thus prevent it from fluttering and thereby prevent disturbing rattling noises.

1. A non-return valve for a ventilation device (10) having
ribs (20) which serve to reinforce said non-return valve (16), and
a wall thickness (S), said wall thickness (S) of said non-return valve (16) does not vary in the region of said ribs (20).

2. The non-return valve according to claim 1, wherein the non-return valve (16) has a longitudinal direction (L), said ribs (20) being provided in said longitudinal direction (L) of said non-return valve (16).

3. The non-return valve according to claim 1, wherein said ribs (20) are parallel to each other.

4. The non-return valve according to claim 1, wherein said ribs (20) are undulatory when viewed in cross-section.

5. The non-return valve according to claim 1, wherein said ribs (20) are trapezoidal when viewed in cross-section.

6. The non-return valve according to claim 1, wherein said ribs (20) are rectangular when viewed in cross-section.

7. The non-return valve according to claim 1, wherein said ribs (20) are sawtooth-like ribs when viewed in cross-section.

8. The non-return valve according to claim 1, wherein said non-return valve (16) is stamped.

9. The non-return valve according to claim 1, wherein said non-return valve (16) is punched.

10. The non-return valve according to claim 1, wherein said non-return valve (16) is injection-molded.

11. A ventilation device, particularly for venting a vehicle interior, having a non-return valve (16) according to claim 1.

12. The ventilation device according to claim 11, wherein a frame (12) is provided on which said non-return valve (16) is mounted.

13. The ventilation device according to claim 11, wherein a frame (12) is provided and said non-return valve (16) is part of said frame (12).
